(19) United States
(12) Patent Application Publication
(10) Pub. No.: US 2004/0264340 A1
(43) Pub. Date: Dec. 30, 2004

(54) Hologram recording apparatus, hologram recording method, hologram reproduction apparatus, hologram reproduction method and hologram recording medium

(75) Inventor: Hisayuki Yamatsu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/861,470

(22) Filed: Jun. 7, 2004

(30) Foreign Application Priority Data
Jun. 25, 2003 (JP) 2003-180916

(51) Int. Cl. G11B 7/00; G11B 5/09

(52) U.S. Cl. 369/103; 369/47.19

(57) ABSTRACT

A hologram recording apparatus and method, a hologram reproduction apparatus and method and a hologram recording medium by which recording and reproduction of address information and clock information on and from a recording medium can be performed without application of an optical disk mastering process. Signal light is spatially modulated based on address information corresponding to a relative position on a hologram recording medium being rotated and is recorded as a hologram on the rotating hologram recording medium. Since the address information is recorded as a hologram, recording of the address information on the hologram recording medium can be performed without application of an optical mastering process.

### BACKGROUND OF THE INVENTION

This invention relates to a hologram recording apparatus, a hologram recording method, a hologram reproduction apparatus and a hologram reproduction method by which a hologram is recorded or reproduced, and also to a hologram recording medium on which a hologram is recorded.

A hologram recording apparatus for recording data on a hologram recording medium has been developed. Where a volume hologram recording medium or volume holographic memory is used as a hologram recording medium, recording of three-dimensional information using the entire volume of the hologram recording medium is allowed. As a result, when compared with a conventional optical disk memory which accepts two-dimensional recording on the surface of the recording medium, remarkable increase of the recording density and the recording capacity can be anticipated with the hologram recording medium.

The volume hologram recording medium may possibly have various forms such as a cube type, a card type and a disk type. However, from the handling, inventory and facility in application of an optical disk technique accumulated for a long period of time, it is considered promising to utilize a recording medium of the disk type.

Incidentally, in order to record or reproduce user data accurately on or from a hologram recording medium, address information and clock information for controlling rotation of the hologram recording medium are preferably recorded on the hologram recording medium.

As a method of recording address information and clock information on a volume hologram recording medium of the disk type, a pre-pit method (a method wherein very small concave elements called pits are recorded in advance on a recording medium) is examined as disclosed, for example, in U.S. Pat. No. 5,917,798.

According to the pre-pit method, however, it is necessary to introduce an optical disk mastering process and perform lithography, injection molding and so forth in a clean room. The optical disk mastering process requires expensive equipments, a great installation area and unique know-how relating to operation and maintenance, and therefore, much labor and cost are required for production of the recording medium.

### SUMMARY OF THE INVENTION

It is an object of the present invention to provide a hologram recording apparatus and a hologram recording method by which recording of address information and clock information on a recording medium can be performed without application of an optical disk mastering process.

It is another object of the present invention to provide a hologram reproduction apparatus and a hologram reproduction method by which address information and clock information recorded on a recording medium can be reproduced suitably.

It is a further object of the present invention to provide a hologram recording medium on which address information and clock information can be recorded without application of an optical disk mastering process.

In order to attain the objects described above, according to an aspect of the present invention, there is provided a hologram recording apparatus, including a laser light source for emitting a laser beam, light splitting means for splitting the laser beam emitted from the laser light source into signal light and reference light, medium rotating means for rotating a hologram recording medium, address information outputting means for outputting address information corresponding to a relative position on the hologram recording medium rotated by the medium rotating means, a spatial modulator for spatially modulating the signal light split by the light splitting means in accordance with the address information outputted from the address information outputting means, first light condensing means for condensing the signal light modulated by the spatial modulator on the hologram recording medium rotated by the medium rotation means, and second light condensing means for condensing the reference light split by the light splitting means at a location substantially same as the location at which the signal light is condensed by the first light condensing means.

In the hologram recording apparatus, the signal light is spatially modulated based on the address information corresponding to the relative position on the hologram recording medium being rotated and is recorded as a hologram on the rotating hologram recording medium. Since the address information is recorded as a hologram, recording of the address information on the hologram recording medium can be performed without application of an optical mastering process.

According to another aspect of the present invention, there is provided a hologram recording method, including a light splitting step of splitting a laser beam into signal light and reference light, a spatially modulating step of spatially modulating the signal light split by the light splitting step in accordance with address information corresponding to a relative position on a rotating hologram recording medium, a first light condensing step of condensing the signal light modulated by the spatially modulating step on the rotating hologram recording medium, and a second light condensing step of condensing the reference light split by the light splitting step at a location substantially same as the location at which the signal light is condensed by the first light condensing step.

In the hologram recording method, address information corresponding to the relative position on the rotating hologram recording medium is produced, and the signal light is spatially modulated based on the produced address information and is recorded as a hologram on the rotating hologram recording medium. Since the address information is recorded as a hologram, recording of the address information on the hologram recording medium can be performed without application of an optical mastering process.

According to a further aspect of the present invention, there is provided a hologram reproduction apparatus, including a laser light source for emitting a laser beam, medium moving means for moving a hologram recording medium, first light condensing means for condensing the laser beam emitted from the laser light source on the hologram recording medium being moved by the medium moving means, second light condensing means for condensing reproduction light emitted from the hologram recording medium in response to the laser beam condensed on the hologram recording medium, a light receiving element for receiving the reproduction light condensed by the second light condensing means, discrimination means for discriminating based on an output of the light receiving element whether or not information included in the hologram of the reproduction light is address information, and movement control means for controlling the movement of the hologram recording medium by the medium moving means based on the address information discriminated by the discrimination means.

In the program reproduction apparatus, it is discriminated based on the output of the light receiving element by which the reproduction light is received whether or not the information included in the hologram reproduced in the reproduction light is address information. Then, movement of the hologram recording medium is performed based on the discriminated address information. Consequently, reproduction of data from the hologram recording medium can be performed readily based on the address information recorded as the hologram on the hologram recording medium.

According to a still further aspect of the present invention, there is provided a hologram reproduction method, including a first light condensing step of condensing a laser beam on a hologram recording medium being moved, a second light condensing step of condensing reproduction light emitted from the hologram recording medium in response to the laser beam condensed on the hologram recording medium at the first light condensing step, a light receiving step of receiving the reproduction light condensed by the second light condensing step using a light receiving element, a discrimination step of discriminating, based on an output of the light receiving element by which the reproduction light is received at the light receiving step, whether or not information included in the hologram reproduced by the reproduction light is address information, and a movement control step of controlling the movement of the hologram recording medium based on the address information discriminated at the discrimination step.

In the program reproduction method, it is discriminated based on the output of the light receiving element by which the reproduction light is received whether or not the information included in the hologram reproduced in the reproduction light is address information. Then, movement of the hologram recording medium is performed based on the discriminated address information. Consequently, reproduction of data from the hologram recording medium can be performed based on the address information recorded as the hologram on the hologram recording medium.

According to a yet further aspect of the present invention, there is provided a hologram recording medium having a first hologram, which represents address information, recorded thereon.

Since address information is recorded as a hologram, recording of address information on the recording medium can be performed without application of an optical disk mastering process.

In summary, with the hologram recording apparatus, hologram recording method, hologram reproduction apparatus, hologram reproduction method and hologram recording medium according to the present invention, recording and reproduction of address information and clock information on and from a recording medium can be performed without application of an optical disk mastering process.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic diagrammatic view showing a hologram recording and reproduction apparatus to which the present invention is applied;

FIG. 2 is a perspective view showing a spatial modulation pattern by a spatial modulator shown in FIG. 1;

FIG. 3 is a schematic view illustrating address information and clock information recorded on a hologram recording medium;

FIG. 4 is a schematic view showing, in an enlarged scale, a location of the hologram recording medium of FIG. 3 at which address information is recorded;

FIGS. 5A to 5C are schematic views showing an example of a hologram of address information in contrast with a hologram of user data; and

FIGS. 6A and 6B are schematic views showing another example of a hologram of address information in contract with the hologram of user data.

### DESCRIPTION OF THE PREFERRED EMBODIMENT

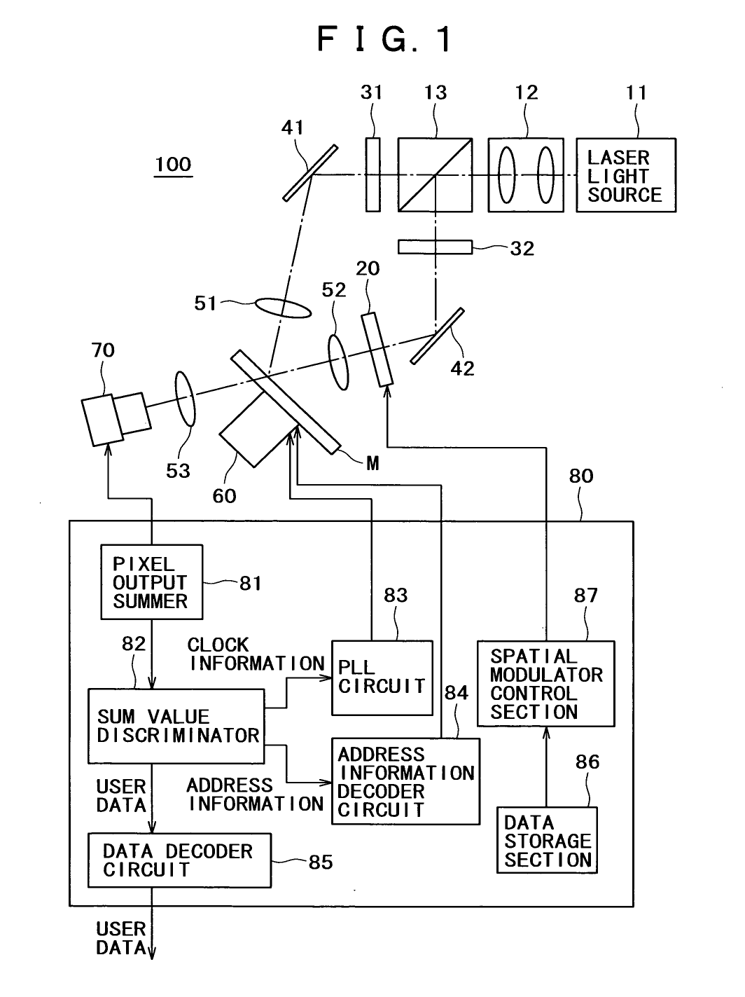

FIG. 1 shows a hologram recording and reproduction apparatus 100 to which the present invention is applied. Referring to FIG. 1, the hologram recording and reproduction apparatus 100 shown includes a laser light source 11, a beam expander 12, a beam splitter 13, a spatial modulator 20, a pair of optical shutters 31 and 32, a pair of mirrors 41 and 42, condenser lenses 51 to 53, a medium rotating and translating apparatus 60, a detector 70 and a control apparatus 80 and performs recording and reproduction on and from a hologram recording medium M.

The laser light source 11 is a light source for emitting a laser beam. The laser light source 11 may be formed from any laser only if interference of signal light (also referred to as “recording light”) thereof with reference light is guaranteed such as, for example, a gas laser, a solid-state laser or a semiconductor laser. The wavelength of the laser beam to be emitted from the laser light source 11 is selected so as to fall within a visible range of 400 nm to 700 nm within which a hologram recording medium such as the hologram recording medium M usually has a sensitivity.

The beam expander 12 is an optical element for expanding the laser beam emitted from the laser light source 11 so as to have a beam diameter over which the laser beam can cover a modulation region of the spatial modulator 20.

The beam splitter 13 is an optical element for splitting the laser beam into signal light and reference light and functions as light splitting means.

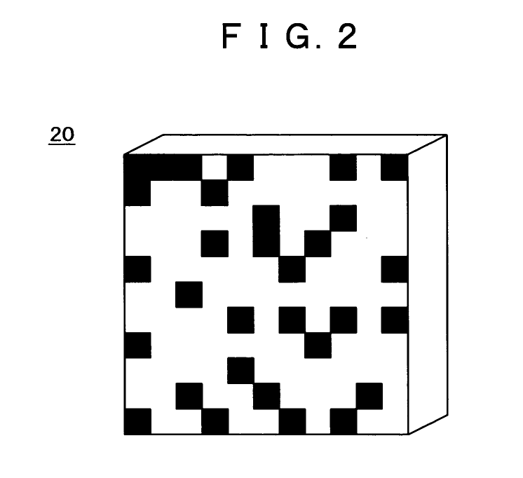

The spatial modulator 20 is a modulator interposed in a light path of the signal light for spatially modulating the optical amplitude (intensity) of the signal light. FIG. 2 is a perspective view showing a spatial modulation pattern of the spatial modulator 20. The spatial modulator 20 may be formed from, for example, a liquid crystal display unit wherein the transmission factor of a large number of pixels is varied independently of each other to produce such a spatial modulation pattern as shown in FIG. 2.

The optical shutters 31 and 32 are optical elements interposed in the light paths of the reference light and the signal light for controlling illumination of the reference light and the reference light, respectively. When the hologram recording medium M is to be reproduced, the optical shutter 32 is closed so that only the reference light may be illuminated at a position of the hologram recording medium M at which a hologram is recorded.

The mirrors 41 and 42 are optical elements for reflecting the reference light and the signal light to change the advancing directions of them, respectively.

The condenser lenses 51 and 52 are optical elements for respectively causing the reference light and the signal light to be illuminated at a substantially same location of the hologram recording medium M. The illuminated reference light and signal light interfere with each other in the hologram recording medium M, and an intensity distribution of interference fringes produced as a result of the interference is recorded as a hologram in the hologram recording medium M.

The condenser lens 53 is an optical element for forming, on the detector 70, an image of reproduction light which is produced when reference light for reproduction is illuminated on the hologram recorded on the hologram recording medium M.

The medium rotating and translating apparatus 60 is an apparatus for rotating and translating the hologram recording medium M.

The detector 70 is a photo detector for detecting reproduction light which is produced when reference light for reproduction is illuminated on the hologram recorded on the hologram recording medium M. The detector 70 may be formed from a CCD unit or a CMOS image sensor wherein a plurality of pixels are arrayed two-dimensionally. Such a modulation pattern as shown in FIG. 2 can be decoded by analyzing the intensity of light inputted to each of the pixels of the detector 70.

### Control Apparatus 80

The control apparatus 80 is used to control the entire hologram recording and reproduction apparatus 100. More particularly, upon reproduction of information, the control apparatus 80 performs identification of address information, clock information and user data based on an output of the detector 70, but upon recording of information, the control apparatus 80 controls the spatial modulator 20. It is to be noted that the identification of address information, clock information and user data is performed based on the sum total of outputs of all pixels of the detector 70 as hereinafter described.

As seen in FIG. 1, the control apparatus 80 includes a pixel output summer 81, a sum value discriminator 82, a PLL circuit 83, an address information decoder circuit 84, a data decoder circuit 85, a data storage section 86 and a spatial modulator control section 87.

The pixel output summer 81 calculates the sum total of the outputs of all of the pixels of the detector 70.

The sum value discriminator 82 discriminates, based on the sum total of the outputs of all pixels of the detector 70 calculated by the pixel output summer 81, which one of address information, clock information and user data the data being currently reproduced is and outputs a result of the discrimination. The sum value discriminator 82 includes a table not shown in which conditions for the discrimination are stored. Which one of address information, clock information and user data the data being currently reproduced is can be discriminated, for example, as given below depending upon the ratio R (hereinafter referred to as “bright state ratio R”) of the number of those pixels which are in a bright state to the total number of pixels of the detector 70:

0.0≦R<0.2, 0.8<R≦1.0 address information

0.2≦R<0.4, 0.6<R<0.8 clock information

0.04≦R≦0.6 address information

Details are hereinafter described.

The PLL (Phase-Locked Loop) circuit 83 is a loop circuit which includes an internal oscillator and synchronizes the frequency and the phase of the internal oscillator with those of clock information outputted from the sum value discriminator 82. The oscillation frequency outputted from the PLL circuit 83 is used to control rotation of the hologram recording medium M by the medium rotating and translating apparatus 60. As a result, movement (including rotation) of the hologram recording medium M by the medium rotating and translating apparatus 60 is performed in accordance with the clock information, and consequently, the speed of recording or reproduction of data on or from the hologram recording medium M can be kept constant.

The address information decoder circuit 84 decodes address information outputted from the sum value discriminator 82. The address of user data being currently reproduced can be discriminated from the decoded address information outputted from the address information decoder circuit 84. The output of the address information decoder circuit 84 is used also for movement of the hologram recording medium M by the medium rotating and translating apparatus 60 for recording or reproduction at or from a desired address.

The data decoder circuit 85 decodes user data outputted from the sum value discriminator 82.

The data storage section 86 is a storage for storing user data to be recorded on the hologram recording medium M.

The spatial modulator control section 87 controls operation of the spatial modulator 20 based on the user data stored in the data storage section 86 to record the user data on the hologram recording medium M.

### Hologram Recording Medium M

The hologram recording medium M is a recording medium on which interference fringes produced by outgoing lights from the condenser lenses 51 and 52 are recorded as a variation of the refractive index. As the refractive index of the hologram recording medium M varies in response to the light exposure, interference fringes produced by interference between the reference light and the signal light can be recorded as a variation of the refractive index on the hologram recording medium M.

The hologram recording medium M may be made of any material irrespective of whether it is an organic material or an inorganic material only if the refractive index thereof varies in response to the intensity of light.

As an inorganic material, a photorefractive material whose refractive index varies in response to the light exposure due to an electro-optical effect such as, for example, lithium niobate (LiNbO₃) can be used.

As an organic material, for example, photo-polymerization type photopolymer can be used. In an initial state of the photo-polymerization type photopolymer, monomer is dispersed uniformly in matrix polymer. If light is illuminated on the photopolymer, then the monomer polymerizes at the light-exposed location. Then, as the polymerization proceeds, the monomer moves from around the polymerized monomer so that the concentration of the monomer changes depending upon the place.

Address information and clock information are recorded on the hologram recording medium M. The address information is used to grasp at which part of the hologram recording medium M reference light is illuminated upon recording or reproduction of the hologram recording medium M. The clock information is used to control rotation of the hologram recording medium M accurately.

Recording of address information and clock information on the hologram recording medium M is performed by recording a hologram at a required portion of the hologram recording medium M (usually on the overall face of the hologram recording medium M) before user data is recorded on the hologram recording medium M.

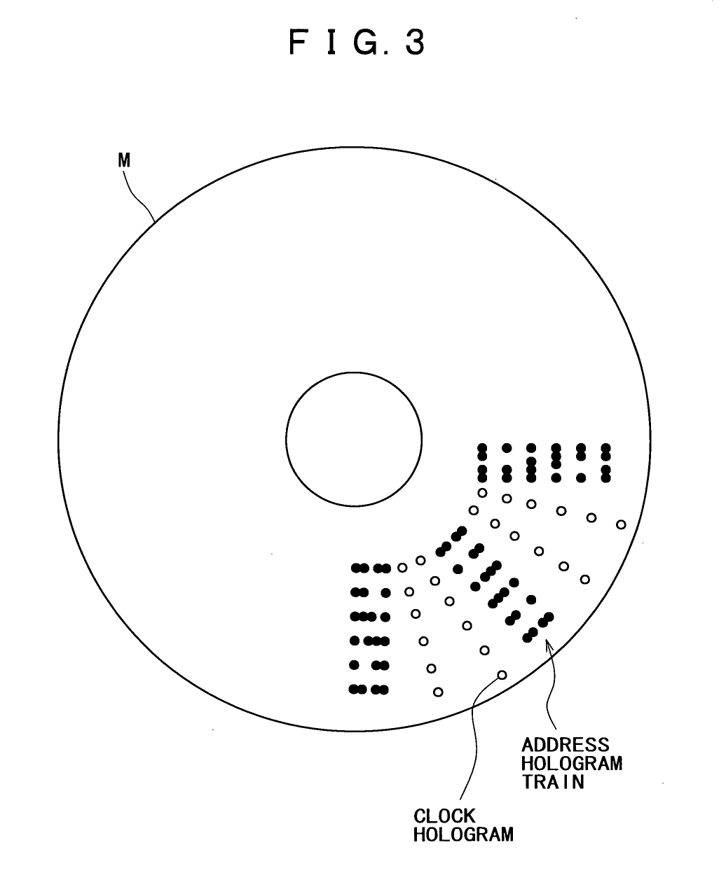

FIG. 3 illustrates address information and clock information recorded on the hologram recording medium M. Solid circles and blank circles represent address information and clock information, respectively. The address information is 5-bit information while the clock information is represented by information of one bit preceding to or following the address information (each of the solid and black circles corresponds to “1” at which a hologram is recorded, and an open space at a distance between solid circles corresponds to “0” at which no hologram is recorded). Each piece of the clock information and the address information is recorded as a hologram at a predetermined rotational angular position and radial position on the hologram recording medium M, and such holograms are successively read upon rotation of the hologram recording medium M.

Since a basically similar recording method can be applied to recording of address information and clock information, recording of address information is described below.

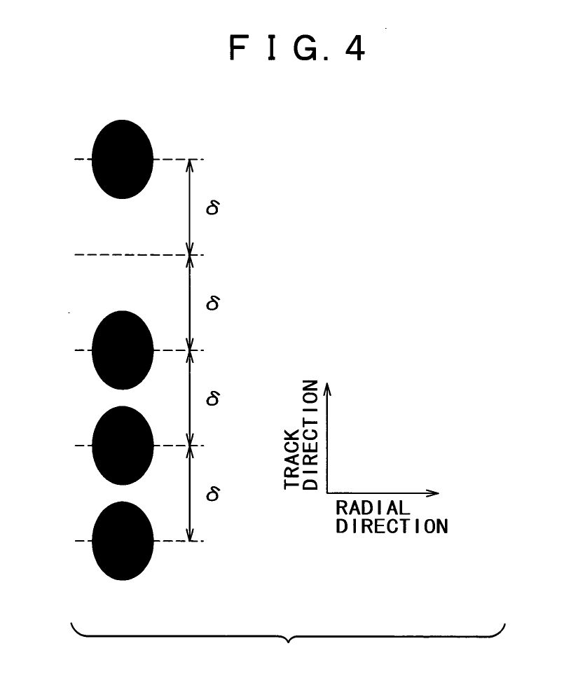

FIG. 4 shows, in an enlarged scale, a location of the hologram recording medium M of FIG. 3 at which address information is recorded. A piece of address information is represented by an “address hologram train” composed of a plurality of holograms recorded at every distance δ in the rotational direction (track direction) on the hologram recording medium M. The plural holograms represent an address of 5 bits where a state wherein a hologram is recorded corresponds to “1” while the other state wherein no hologram is recorded corresponds to “0” (or vice versa).

While, in the address information illustrated in FIG. 4, one hologram has information of one bit, one hologram may otherwise have information of two or more bits. Further, it can be determined arbitrarily by what number of holograms a piece of address information is represented. Address information may be represented by one hologram or a plurality of holograms.

In the hologram recording and reproduction apparatus 100, reception of reproduction light from either of user data and address information is performed using the detector 70. Accordingly, it is necessary to discriminate whether reproduction light being received by the detector 70 at a certain point of time represents user data or address data.

This discrimination can be achieved by determining the sum total of outputs of all pixels of the detector 70 and modulating user data and address information such that the sum total is different between the user data and the address data.

A state wherein one pixel of the spatial modulator 20 is on (passes light therethrough) is represented by H while another state wherein it is off (intercepts the light) is represented by L. Where modulation is performed based on user data, such a modulation pattern as shown in FIG. 2 wherein H and L pixels are distributed at random is obtained. Here, the modulation can be performed under the condition that fixed numbers of pixels in one hologram individually represent H and L without fail. In this instance, also the sum total of the outputs of all pixels of the detector 70 is fixed.

As the simplest example, such modulation that one half of the number of all pixels of the detector represents H or L, that is, the numbers of the pixels which represent H and L are equal to each other, is sometimes performed. Although some restriction on modulation of user data may possibly make it impossible to permit existence of equal numbers of H and L pixels, also in this instance, it is possible to make the total numbers of H and L pixels individually fixed numbers without fail.

With regard to address information, the ratio of existing H and L pixels in one hologram can be set suitably to a different value from that of user data. By the setting, the sum total of the outputs of all pixels of the detector 70 can have different values depending upon whether user data is received or address information is received. As a result, it can be discriminated whether a hologram being read represents user data or address information.

For example, it is assumed that both of the numbers of pixels of the detector 70 and the spatial modulator 20 are N, and when light is inputted to one pixel of the detector 70, an output of I is generated. Here, an output offset when no light is inputted to one pixel of the detector 70 is ignored. In other words, it is assumed that the output of one pixel corresponding to the L state is 0.

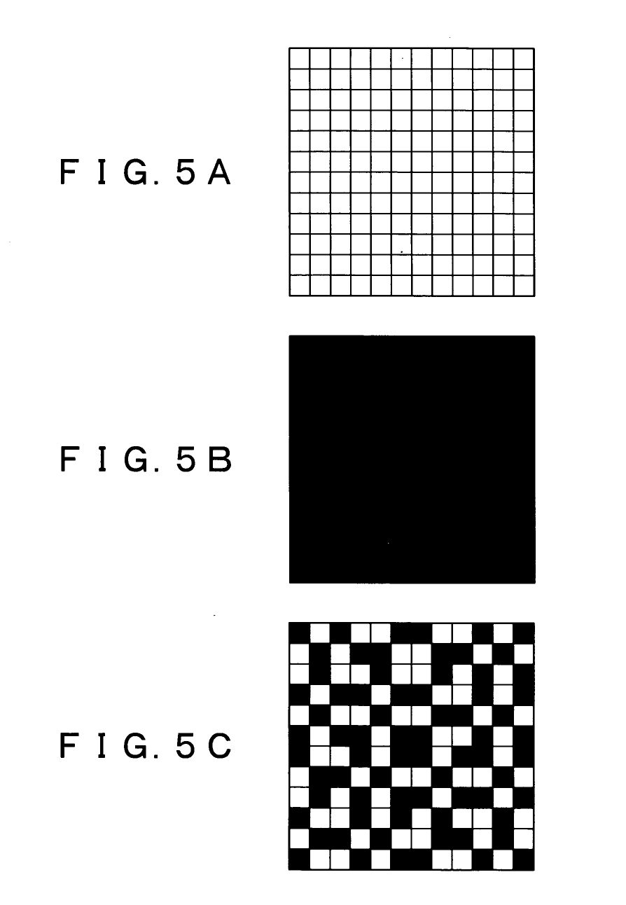

FIGS. 5A, 5B and 5C show an example of a hologram of address information in contrast with a hologram of user data. In particular, FIGS. 5A and 5B show holograms of address information representative of the state of “1” (corresponding to a location of a solid circle in FIGS. 3 and 4) and the state of “0” (corresponding to a location at which a solid circle misses in FIGS. 3 and 4), respectively, while FIG. 5C shows a hologram of user data. Here, it is assumed that the state of “1” is represented by all pixels in the H state while the state of “0” is represented by all pixels in the L state (FIGS. 5A and 5B, respectively). On the other hand, it is assumed that the hologram of the user data includes numbers of pixels in the H state and the L state which are equal to each other (FIG. 5C).

Where the setting described above is adopted, when the address information “1” is reproduced, the sum total of the outputs of all pixels of the detector 70 is N·I. On the other hand, when the address information “0” is reproduced, the sum total of the outputs of all pixels of the detector 70 is 0. Further, when user data is reproduced, the sum total of the outputs of all pixels of the detector 70 is N·I/2. Accordingly, since the sum total of the outputs of all pixels of the detector 70 is different depending upon whether user data is reproduced or address information is reproduced, it can be discriminated whether a hologram being reproduced represents user data or address information.

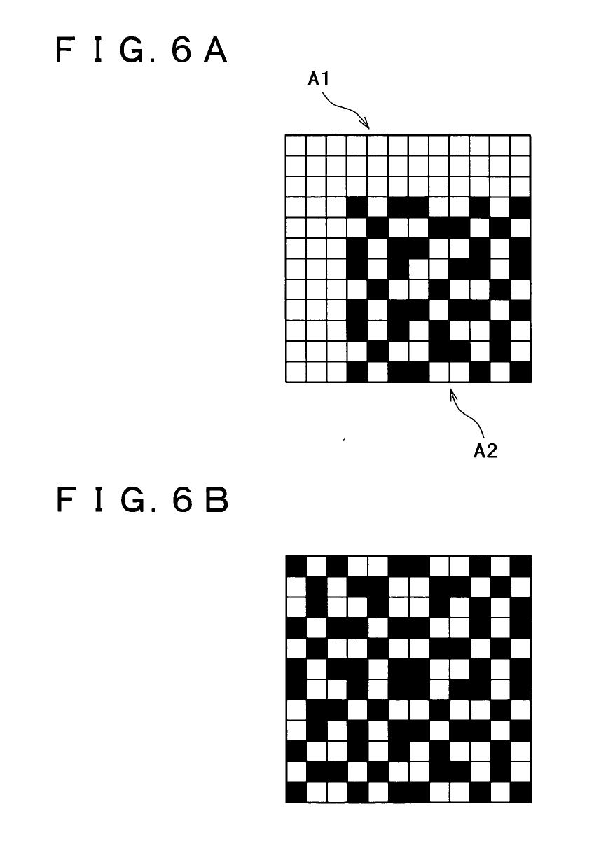

FIGS. 6A and 6B show another example of a hologram of address information in contrast with a hologram of user data. More particularly, FIG. 6A shows a hologram of address information while FIG. 6B shows a hologram of user data.

Here, one hologram has information of 2 bits or more, and a piece of address information is represented by one or more holograms. Further, one hologram has a region (unused region A1) which is not used to represent information, and all of those pixels which form the unused region Al are modulated to either H or L. Further, in the other region having information (information region A2), the numbers of pixels of H and L are set equal to each other. For example, if one third of the pixel number N of the spatial modulator 20 and the detector 70 are included in the unused region and all modulated to H whereas the remaining N·2/3 pixels are modulated so that the numbers of pixels of H and L are equal to each other, then the sum total of the outputs of all pixels of the detector 70 upon reproduction of address information is N·I·2/3.

Since this value is different from NI/2 which is the sum total of the outputs of all pixels of the detector 70 upon reproduction of user data, it can be discriminated whether or not a hologram being reproduced represents user data or address information.

While recording of address information is described above, when both of address information and clock information are recoded, also it is necessary so that they can be identified from each other.

For example, if the numbers of H and L pixels in one hologram having clock information are set different from those of the address information and user data, then discrimination among the clock information, address information and user data (discrimination of the type of information) is permitted.

Where separate regions are used as seen in FIG. 6A, discrimination of the type of information is permitted by setting the numbers of H and L pixels in the information region A2 to fixed values irrespective of whether the type of information is clock information, address information or user data and setting the area ratio between the unused region Al and the information region A2 to different values among the different types of information. As a result, the numbers of H and L pixels in one hologram have different values depending upon the type of information.

### Operation of the Hologram Recording and Reproduction Apparatus 100

A. Recording of Address Information and Clock Information on the Hologram Recording Medium M

First, recording of address information and clock information on the hologram recording medium M is described.

At this time, it is assumed that address information and clock information to be recorded on the hologram recording medium M including an order of them to be recorded are stored in the data storage section 86. It is to be noted that it is otherwise possible to suitably produce address information and clock information on the spot without storing them in advance.

It is assumed that the hologram recording medium M is rotated and translated based on an oscillation frequency from the PLL circuit 83 and data are recorded, for example, spirally on the hologram recording medium M. This movement of the hologram recording medium M is performed in accordance with the order in which the address information and the clock information are recorded.

The laser beam outputted from the laser light source 11 is expanded in beam diameter by the beam expander 12 and split into two lights (reference light and signal light) by the beam splitter 13.

The reference light is diverted by the mirror 41, passes through the condenser lens 51 and is condensed on the hologram recording medium M.

The signal light is diverted by the mirror 42 and enters the spatial modulator 20. The spatial modulator 20 is controlled in accordance with the address information and clock information stored in the data storage section 86 so that each of the pixels of the spatial modulator 20 independently assumes one of bright and dark transmission states.

The signal light having passed through the spatial modulator 20 is condensed on the hologram recording medium M through the condenser lens 52. At this time, the reference light and the signal light are condensed at a substantially same location of the hologram recording medium M, and consequently, interference fringes are formed in the hologram recording medium M. Thus, the refractive index of the hologram recording medium M changes in response to the interference fringes thereby to perform recording of the address information and clock information in the hologram recording medium M.

B. Recording of User Data on the Hologram Recording Medium M

Recording of user data on the hologram recording medium M on which address information and clock information are recorded is described.

At this time, it is assumed that user data to be recorded on the hologram recording medium M are stored in the data storage section 86.

The hologram recording medium M is rotated and translated based on an oscillation frequency from the PLL circuit 83 and recording of data on the hologram recording medium M is performed. Upon such recording, the movement of the hologram recording medium M is controlled in accordance with the address information or clock information reproduced from the hologram recording medium M. In particular, when recording of user data on the hologram recording medium M is to be preformed, reproduction of address information and clock information is performed prior to the recording of data on the hologram recording medium M. The switching between recording and reproduction is performed by transmission/interception of the signal light by the optical shutters 31 and 32.

Reproduction of address information and clock information and recording of user data are described separately.

1. Reproduction of Address Information and Clock Information from the Hologram Recording Medium M

Reproduction of address information and clock information from the hologram recording medium M is described.

The laser beam emitted from the laser light source 11 is expanded in beam diameter by the beam expander 12 and split into two lights (reference light and signal light) by the beam splitter 13.

In order to reproduce address information or clock information from the hologram recording medium M, from between the two lights (reference light and signal light) obtained by splitting at beam splitter 13 the laser beam emitted from the laser light source 11, the signal light is intercepted by the optical shutter 32 while only the reference light is condensed on the hologram recording medium M by the condenser lens 51.

The reference light inputted to the hologram recording medium M is diffracted in accordance with the refractive index distribution in the hologram recording medium M to produce reproduction light. The produced reproduction light goes out, upon recording on the hologram recording medium M, along an extension line in the advancing direction of the signal light for recording in which the signal light has been inputted to the hologram recording medium M. The reproduction light is converged by the condenser lens 53 and introduced into the detector 70. The detector 70 can reproduce the data recorded in the hologram recording medium M as the intensities of light received by the individual pixels.

Address information and clock information can be separated by the sum value discriminator 82 by integrating the intensities of light at all of the pixels of the detector 70 and inputting the integrated value to the sum value discriminator 82. The address information and the clock information are used to control the movement of the hologram recording medium M. In particular, the rate of recording of data on the hologram recording medium M is adjusted with the clock information while at which location (at which address) of the hologram recording medium M user data should be recorded is determined with the address information.

2. Recording of User Data on the Hologram Recording Medium M

If the condensed location of the laser beam is set to an address at which data should be recorded, then recording of user data on the hologram recording medium M is performed.

In order to record user data, the interception of the signal light by the optical shutter 32 is canceled to allow the signal light to pass through the optical shutter 32. The signal light is diverted by the mirror 42 and enters the spatial modulator 20. At this time, the spatial modulator 20 is controlled in accordance with user data stored in the data storage section 86.

The signal light having passed through the spatial modulator 20 is condensed on the hologram recording medium M by the condenser lens 52. At this time, since the reference light and the signal light are condensed at a substantially same location of the hologram recording medium M, interference fringes are formed in the hologram recording medium M, and the refractive index of the hologram recording medium M varies in accordance with the interference fringes thereby to record the user data on the hologram recording medium M.

After the recording of the user data at the predetermined address is performed, in order to confirm another address to which recording should be performed subsequently, reproduction of address information and clock information described in the paragraph 1 above is performed, and then recording of the address data described in the paragraph 2 above is performed. By allowing the signal light to intermittently pass by means of the optical shutter 32 in this manner, recording and reproduction of the paragraphs 1 and 2 above are performed alternately, and recording of the user data at the desired address is performed.

C. Reproduction of User Data from the Hologram Recording Medium M

Reproduction of user data from the hologram recording medium M on which address information, clock information and user data are recorded is described.

Reproduction of address information, clock information and user data is performed basically in the procedure described in the item B.1. above. At this time, the hologram recording medium M is rotated and translated based on an oscillation frequency from the PLL circuit 83 to perform recording of data on the hologram recording medium M. The movement of the hologram recording medium M is controlled with address information and clock information reproduced from the hologram recording medium M at this time.

In this instance, since recording must not be performed, the signal light is intercept by the optical shutter 32.

As described above, since address information and clock information are recorded as holograms on the hologram recording medium M before user data are recorded on the hologram recording medium M, recording or reproduction of data on or from the hologram recording medium M can be performed stably. Since the recording of address information and clock information is performed using a hologram similarly to the user data, process equipments which have been essentially required for manufacture of hologram recording media of the pre-pit type such as the hologram recording medium M can be eliminated. Consequently the cost for the hologram recording medium M can be reduced significantly.

Further, when information is to be recorded on the hologram recording medium M, where the signal light is spatially modulated such that the spatial integration amount of the intensity of hologram reproduction light differs among the address information, clock information and user data, the address information, clock information and user data can be discriminated from one another.

While a preferred embodiment of the present invention has been described using specific terms, such description is for illustrative purposes only, and it is to be understood that changes and variations may be made without departing from the spirit or scope of the following claims.

What is claimed is:

1. A hologram recording apparatus, comprising:
a laser light source for emitting a laser beam;
light splitting means for splitting the laser beam emitted from said laser light source into signal light and reference light;
medium rotating means for rotating a hologram recording medium;
address information outputting means for outputting address information corresponding to a relative position on the hologram recording medium rotated by said medium rotating means;
a spatial modulator for spatially modulating the signal light split by said light splitting means in accordance with the address information outputted from said address information outputting means;
first light condensing means for condensing the signal light modulated by said spatial modulator on the hologram recording medium rotated by said medium rotation means; and
second light condensing means for condensing the reference light split by said light splitting means at a location substantially same as the location at which the signal light is condensed by said first light condensing means.

2. The hologram recording apparatus according to claim 1, wherein said spatial modulator for spatially modulating the signal light in accordance with the address information includes a plurality of pixels each of which can assume one of a bright state and a dark state, and the ratio of the number of pixels which are in the bright state to the total number of pixels is within a first predetermined range.

3. The hologram recording apparatus according to claim 1, further comprising clock information outputting means for outputting clock information corresponding to the speed of rotation of the hologram recording medium rotated by said medium rotating means, said spatial modulator spatially modulating the signal light in accordance with the address information outputted from said address information outputting means and the clock information outputted from said clock information outputting means.

4. The hologram recording apparatus according to claim 3, wherein said spatial modulator for spatially modulating the signal light in accordance with the clock information includes a plurality of pixels each of which can assume one of a bright state and a dark state, and the ratio of the number of pixels which are in the bright state to the total number of pixels is within a second predetermined range.

5. A hologram recording method, comprising:
a light splitting step of splitting a laser beam into signal light and reference light;
a spatially modulating step of spatially modulating the signal light split by the light splitting step in accordance with address information corresponding to a relative position on a rotating hologram recording medium;
a first light condensing step of condensing the signal light modulated by the spatially modulating step on the rotating hologram recording medium; and
a second light condensing step of condensing the reference light split by the light splitting step at a location substantially same as the location at which the signal light is condensed by the first light condensing step.

6. A hologram reproduction apparatus, comprising:
a laser light source for-emitting a laser beam;
medium moving means for moving a hologram recording medium;
first light condensing means for condensing the laser beam emitted from said laser light source on the hologram recording medium being moved by said medium moving means;
second light condensing means for condensing reproduction light emitted from the hologram recording medium in response to the laser beam condensed on the hologram recording medium;
a light receiving element for receiving the reproduction light condensed by said second light condensing means;
discrimination means for discriminating based on an output of said light receiving element whether or not information included in the hologram of the reproduction light is address information; and
movement control means for controlling the movement of the hologram recording medium by said medium moving means based on the address information discriminated by said discrimination means.

7. The hologram reproduction apparatus according to claim 6, wherein said discrimination means discriminates based on the output of said light receiving element whether or not the information included in the hologram reproduced in the reproduction light is address information or clock information, and the control of the movement of the hologram recording medium by said movement control means is performed based on the clock information discriminated by said discrimination means.

8. The hologram reproduction apparatus according to claim 6, wherein the discrimination of whether or not the information included in the hologram of the reproduction light is address information is performed based on integration of the amounts of light received by said light receiving elements.

9. The hologram reproduction apparatus according to claim 8, wherein said light receiving element includes a plurality of pixels.

10. A hologram reproduction method, comprising:
a first light condensing step of condensing a laser beam on a hologram recording medium being moved;
a second light condensing step of condensing reproduction light emitted from the hologram recording medium in response to the laser beam condensed on the hologram recording medium at the first light condensing step;
a light receiving step of receiving the reproduction light condensed by the second light condensing step using a light receiving element;
a discrimination step of discriminating, based on an output of said light receiving element by which the reproduction light is received at the light receiving step, whether or not information included in the hologram reproduced by the reproduction light is address information; and
a movement control step of controlling the movement of the hologram recording medium based on the address information discriminated at the discrimination step.

11. The hologram reproduction method according to claim 10, wherein, at the discrimination step, it is discriminated based on the output of said light receiving element whether or not the information included in the hologram reproduced in the reproduction light is address information or clock information, and the control of the movement of the hologram recording medium at the movement control step is performed based on the clock information discriminated at the discrimination step.

12. A hologram recording medium having a first hologram, which represents address information, recorded thereon.

13. The hologram recording medium according to claim 12, wherein the first hologram includes a plurality of pixels each of which can assume one of a bright state and a dark state, and the ratio of the number of pixels which are in the bright state to the total number of pixels is within a first predetermined range.

14. The hologram recording medium according to claim 12, further having a second hologram, which represents clock information, recorded thereon.

15. The hologram recording medium according to claim 14, wherein the second hologram includes a plurality of pixels each of which can assume one of a bright state and a dark state, and the ratio of the number of pixels which are in the bright state to the total number of pixels is within a second predetermined range.
